(19) United States
(12) Patent Application Publication
(10) Pub. No.: US 2025/0346250 A1
(43) Pub. Date: Nov. 13, 2025

(54) Apparatus for Controlling Vehicle and Method Thereof

(71) Applicants: Hyundai Motor Company, Seoul (KR); Kia Corporation, Seoul (KR)

(72) Inventor: Soo Young Hyun, Hwaseong-Si (KR)

(21) Appl. No.: 18/965,731

(22) Filed: Dec. 2, 2024

(30) Foreign Application Priority Data
May 10, 2024 (KR) 10-2024-0062039

(51) Int. Cl. B60W 60/00; B60W 30/18

(52) U.S. Cl. CPC B60W 60/001; B60W 30/18154; B60W 2556/40

(57) ABSTRACT

A vehicle control device may include memory that stores map information, a sensor that determines at least a location or a heading of a vehicle, and a processor. The processor may determine, based on at least one of the location of the vehicle or the heading of the vehicle, an intersection on a path of the vehicle, determine, based on the map information, a region of interest that comprises the intersection, determine, based on at least one of a traffic lane in the region of interest or a lane attribute of the traffic lane, an intersection attribute of the intersection, and control, based on the intersection attribute, an operation of the vehicle.

### CROSS-REFERENCE TO RELATED APPLICATION

This application claims the benefit of priority to Korean Patent Application No. 10-2024-0062039, filed in the Korean Intellectual Property Office on May 10, 2024, the entire contents of which are incorporated herein by reference.

### TECHNICAL FIELD

The present disclosure relates to an apparatus for controlling vehicle and method thereof, and more specifically, to a technology for determining the attribute of an intersection.

### BACKGROUND

An intersection (e.g., an at-grade junction) may be identified under various circumstances while a vehicle is traveling along its traveling path in a driving assistance mode and/or an autonomous driving mode.

In particular, intersections pose an increased risk of accidents, and therefore, various strategies may be used to accurately determine intersections and guide a vehicle through intersections efficiently and safely.

### SUMMARY

The present disclosure has been made to solve the above-mentioned problems occurring in at least some implementations while advantages achieved by those implementations are maintained intact.

An aspect of the present disclosure provides a vehicle control device and a vehicle control method, which accurately determine an intersection attribute of an intersection by using lane attributes of lanes included in the intersection.

An aspect of the present disclosure provides a vehicle control device and a vehicle control method, which establish a driving strategy corresponding to road conditions by accurately determining an intersection attribute.

An aspect of the present disclosure provides a vehicle control device and a vehicle control method, which accurately determine an intersection attribute by determining the intersection attribute using map information and vehicle sensor information.

The technical problems to be solved by the present disclosure are not limited to the aforementioned problems, and any other technical problems not mentioned herein will be clearly understood from the following description by those skilled in the art to which the present disclosure pertains.

According to one or more example embodiments of the present disclosure, a vehicle control device of a vehicle may include: memory configured to store map information; a sensor configured to determine at least a location of the vehicle or a heading of the vehicle; and a processor. The processor may be configured to: determine, based on at least one of the location of the vehicle or the heading of the vehicle, an intersection on a path of the vehicle; determine, based on the map information, a region of interest that includes the intersection; determine, based on at least one of a traffic lane in the region of interest or a lane attribute of the traffic lane, an intersection attribute of the intersection; and control, based on the intersection attribute, an operation of the vehicle.

The processor may be further configured to: determine, from the map information and based on the location of the vehicle, a lane segment that diverges or merges within the path of the vehicle; and determine, within the region of interest, the intersection that includes the lane segment.

The processor may be further configured to: determine, based on at least one of a starting point of a lane segment or an end point of the lane segment, the lane attribute. The lane segment may include a portion, of the traffic lane in which the vehicle is traveling, that is inside the region of interest.

The processor may be further configured to: determine a first vector tangent to the lane segment at the starting point of the lane segment; determine a second vector tangent to the lane segment at the end point of the lane segment; and determine, based on an angle between the first vector and the second vector, whether the path of the vehicle along the lane segment is straight.

The processor may be further configured to: determine, based on a cross product of the first vector and the second vector, whether the path of the vehicle includes a left turn or a right turn.

The processor may be configured to determine the intersection attribute by: determining, based on the lane attribute indicating a left turn lane and based on the angle being greater than a threshold value, that U-turns are permitted in the intersection.

The processor may be further configured to: determine drivable lanes within the intersection; and determine directed graphs respectively corresponding to the drivable lanes.

The processor may be further configured to: determine, based on the directed graphs, a type of the intersection.

The type of the intersection may include at least one of: a three-way intersection, a three-way intersection without a left turn, a four-way intersection, a five-way intersection, a roundabout, an overpass, or an underpass.

The processor may be further configured to determine the intersection attribute by: determining the intersection attribute based on the lane attribute and the type of the intersection.

The processor may be configured to determine the intersection attribute by: determining, based on the lane attribute successively indicating a plurality of left turns, that the lane attribute further indicates a loop; and determining, based on the lane attribute indicating the loop, that the intersection attribute indicates a roundabout.

The sensor may include at least one of: a global positioning system (GPS) sensor, a gyroscope, an accelerometer, or a magnetometer.

According to one or more example embodiments of the present disclosure, a method performed by an apparatus of a vehicle may include: determining, by a processor of the vehicle and based on at least one of a location of the vehicle or a heading of the vehicle, an intersection on a path of the vehicle; determining, by the processor and based on map information stored in memory of the vehicle, a region of interest that includes the intersection; determining, by the processor and based on at least one of a traffic lane in the region of interest or a lane attribute of the traffic lane, an intersection attribute of the intersection; and controlling, by the processor based on the intersection attribute, an operation of the vehicle.

The method may further include: determining, from the map information and based on the location of the vehicle, a lane segment that diverges or merges within the path of the vehicle; and determining, within the region of interest, the intersection that includes the lane segment.

The method may further include: determining, based on at least one of a starting point of a lane segment, or an end point of the lane segment, the lane attribute. The lane segment may include a portion, of the traffic lane in which the vehicle is traveling, that is inside the region of interest.

The method may further include: determining a first vector tangent to the lane segment at the starting point of the lane segment; determining a second vector tangent to the lane segment at the end point of the lane segment; and determining, based on an angle between the first vector and the second vector, whether the path of the vehicle along the lane segment is straight.

The method may further include: determining, based on a cross product of the first vector and the second vector, whether the path of the vehicle includes a left turn or a right turn.

Determining the intersection attribute may include: determining, based on the lane attribute indicating a left turn lane and based on the angle being greater than a threshold value, that U-turns are permitted in the intersection.

The method may further include: determining drivable lanes within the intersection; and determining directed graphs respectively corresponding to the drivable lanes.

The method may further include: determining, based on the directed graphs, a type of the intersection. Determining the intersection attribute may include: determining the intersection attribute based on the lane attribute and the type of the intersection. The type of the intersection may include at least one of: a three-way intersection, a three-way intersection without a left turn, a four-way intersection, a five-way intersection, a roundabout, an overpass, or an underpass.

### BRIEF DESCRIPTION OF THE DRAWINGS

The above and other objects, features and advantages of the present disclosure will be more apparent from the following detailed description taken in conjunction with the accompanying drawings:

FIG. 1 shows an example of a block diagram relating to a vehicle control device;

FIG. 2 shows an example of outputting an intersection attribute;

FIG. 3 shows an example of determining lane attributes;

FIG. 4 shows an example of determining an intersection attribute;

FIG. 5 shows an example of identifying lanes within an intersection;

FIG. 6 shows an example of obtaining directed graphs;

FIG. 7 shows an example of identifying a roundabout and/or a U-turn lane;

FIG. 8 shows an example of a flowchart related to a vehicle control method; and

FIG. 9 shows a computing system related to a vehicle control device or a vehicle control method.

### DETAILED DESCRIPTION

Hereinafter, one or more example embodiments of the present disclosure will be described in detail with reference to the exemplary drawings. In adding the reference numerals to the components of each drawing, it should be noted that the identical or equivalent component is designated by the identical numeral even when they are displayed on other drawings. Further, in describing the example embodiments of the present disclosure, a detailed description of well-known features or functions will be ruled out in order not to unnecessarily obscure the gist of the present disclosure.

In describing the components of the one or more example embodiments according to the present disclosure, terms such as first, second, “A”, “B”, (a), (b), and the like may be used. These terms are merely intended to distinguish one component from another component, and the terms do not limit the nature, sequence or order of the constituent components. Unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, and C”, “A, B, or C”, “at least one of A, B, and C”, “at least one of A, B, or C”, as used herein may mean each listed item or all possible combinations of the listed items. For example, “at least one of A or B” may refer to (1) at least one A; (2) at least one B; or (3) at least one A and at least one B.

In at least some implementations, whether there is an intersection may be determined by comparing the length of a lane with the distance traveled by a vehicle. Such implementations may be prone to errors and may cause problems with edge cases for intersections with unusual shapes.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein. One or more features associated with autonomous driving control may be activated based on configured autonomous driving control setting(s) (e.g., based on at least one of: an autonomous driving classification, a selection of an autonomous driving level for a vehicle, etc.).

Based on one or more features (e.g., determining attributes of an intersection) described herein, an operation of the vehicle may be controlled. The vehicle control may include various operational controls associated with the vehicle (e.g., autonomous driving control, sensor control, braking control, braking time control, acceleration control, acceleration change rate control, alarm timing control, forward collision warning time control, etc.).

One or more auxiliary devices (e.g., engine brake, exhaust brake, hydraulic retarder, electric retarder, regenerative brake, etc.) may also be controlled, for example, based on one or more features (e.g., determining attributes of an intersection) described herein. One or more communication devices (e.g., a modem, a network adapter, a radio transceiver, an antenna, etc., that is capable of communicating via one or more wired or wireless communication protocols, such as Ethernet, Wi-Fi, near-field communication (NFC), Bluetooth, Long-Term Evolution (LTE), 5G New Radio (NR), vehicle-to-everything (V2X), etc.) may also be controlled, for example, based on one or more features (e.g., determining attributes of an intersection) described herein.

Minimum risk maneuver (MRM) operation(s) may also be controlled, for example, based on one or more features (e.g., determining attributes of an intersection) described herein. A minimal risk maneuvering operation (e.g., a minimal risk maneuver, a minimum risk maneuver) may be a maneuvering operation of a vehicle to minimize (e.g., reduce) a risk of collision with surrounding vehicles in order to reach a lowered (e.g., minimum) risk state. A minimal risk maneuver may be an operation that may be activated during autonomous driving of the vehicle when a driver is unable to respond to a request to intervene. During the minimal risk maneuver, one or more processors of the vehicle may control a driving operation of the vehicle for a set period of time. For example, the minimum risk maneuver may be used when it is determined that a vehicle is approaching and/or entering an intersection.

Biased driving operation(s) may also be controlled, for example, based on one or more features (e.g., determining attributes of an intersection) described herein. A driving control apparatus may perform a biased driving control. To perform a biased driving, the driving control apparatus may control the vehicle to drive in a lane by maintaining a lateral distance between the position of the center of the vehicle and the center of the lane. For example, the driving control apparatus may control the vehicle to stay in the lane but not in the center of the lane.

The driving control apparatus may identify a biased target lateral distance for biased driving control. For example, a biased target lateral distance may comprise an intentionally adjusted lateral distance that a vehicle may aim to maintain from a reference point, such as the center of a lane or another vehicle, during maneuvers such as lane changes. This adjustment may be made to improve the vehicle's stability, safety, and/or performance under varying driving conditions, etc. For example, during a lane change, the driving control system may bias the lateral distance to keep a safer gap from adjacent vehicles, considering factors such as the vehicle's speed, road conditions, and/or the presence of obstacles, etc.

One or more sensors (e.g., IMU sensors, camera, LIDAR, RADAR, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, inverter, converter, motor controller, power distribution unit, high-voltage wiring and connectors, auxiliary power modules, charging interface, etc.) may also be controlled, for example, based on one or more features (e.g., determining attributes of an intersection) described herein.

An operation control for autonomous driving of the vehicle may include various driving control of the vehicle by the vehicle control device (e.g., acceleration, deceleration, steering control, gear shifting control, braking system control, traction control, stability control, cruise control, lane keeping assist control, collision avoidance system control, emergency brake assistance control, traffic sign recognition control, adaptive headlight control, etc.).

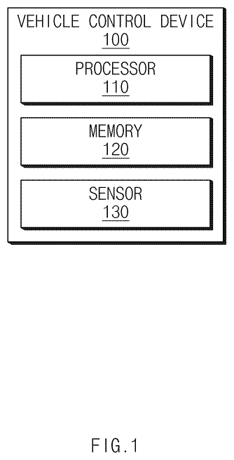

Hereinafter, one or more example embodiments of the present disclosure will be described in detail with reference to FIGS. 1 to 9.

FIG. 1 shows an example of a block diagram relating to a vehicle control device.

Described below, ‘device’ may be included in ‘apparatus’.

Referring to FIG. 1, a vehicle control device 100 may be implemented inside or outside a vehicle, and part of components included in the vehicle control device 100 may be implemented inside or outside the vehicle. In this case, the vehicle control device 100 may be integrally formed with internal control units of the vehicle, or may be implemented as a separate device and connected to the control units of the vehicle by separate connection means. For example, the vehicle control device 100 may further include components not shown in FIG. 1.

Referring to FIG. 1, the vehicle control device 100 may include a processor 110, a memory 120, and a sensor 130. The processor 110, the memory 120, or the sensor 130 may be electronically and/or operably coupled with each other by an electronical component including a communication bus.

Hereinafter, pieces of hardware being operatively combined may include that a direct connection or an indirect connection between the pieces of hardware is established in a wired and/or wireless manner, such that second hardware is controlled by first hardware among the pieces of hardware.

Although shown in different blocks, the present disclosure is not limited thereto. For example, a part of the pieces of hardware of FIG. 1 may be included in a single integrated circuit, including a system on a chip (SoC). The types and/or number of pieces of hardware included within vehicle control device 100 are not limited to those shown in FIG. 1. For example, the vehicle control device 100 may include only a part of the hardware shown in FIG. 1.

The vehicle control device 100 may include hardware for processing data based on one or more instructions. The hardware for processing the data may include a processor 110.

For example, the hardware for processing data may include an arithmetic and logic unit (ALU), a floating-point unit (FPU), a field programmable gate array (FPGA), a central processing unit (CPU), and/or an application processor (AP). The processor 110 may have the structure of a single-core processor, or the structure of a multi-core processor including dual core, quad core, hexa core, or octa core.

The memory 120 of the vehicle control device 100 may include hardware components for storing instructions that are input to and/or output from the processor 110 of the vehicle control device 100.

For example, the memory 120 may include a volatile memory including a random-access memory (RAM), or a non-volatile memory including a read-only memory (ROM).

For example, the volatile memory may include at least one of dynamic RAM (DRAM), static RAM (SRAM), cache RAM or pseudo SRAM (PSRAM), or any combination thereof.

For example, the non-volatile memory may include at least one of programmable ROM (PROM), erasable PROM (EPROM), electrically erasable PROM (EEPROM), flash memory, hard disk, compact disc read-only memory (CD-ROM), solid state drive (SSD) or embedded multi-media card (eMMC), or any combination thereof.

For example, map information may be stored in the memory 120. For example, the map information may include at least one of a high definition (HD) map, or a general map, or any combination thereof.

The sensor 130 of the vehicle control device 100 may identify at least one of the location of the vehicle, or the heading direction (also referred to as a heading) of the vehicle, or any combination thereof. For example, the sensor 130 may include at least one of a global positioning system (GPS) sensor, a gyroscope (also referred to as a gyro sensor), an accelerometer (also referred to as an acceleration sensor), or magnetometer (also referred to as a geomagnetic sensor), or any combination thereof.

The processor 110 of the vehicle control device 100 may identify the location of a vehicle in a coordinate system expressed by map information, based on the sensor 130.

The processor 110 may identify, from map information, an intersection within a path on which the vehicle is traveling. For example, the processor 110 may identify a region of interest (ROI) including the intersection, based on identifying, from map information, the intersection within a path on which the vehicle is traveling.

For example, the processor 110 may identify, from the map information, sub-lanes that diverge or merge within the path on which the vehicle is traveling based on identifying the location of the vehicle.

For example, processor 110 may identify, within a region of interest, an intersection that includes sub-lanes.

The processor 110 may determine an intersection attribute for the intersection based on at least one of traffic lanes (also referred to as lanes) in the region of interest or lane attributes for the lanes, or any combination thereof.

For example, the processor 110 may identify lane attributes based on at least one of the starting point of a sub-lane or the end point of the sub-lane, or any combination thereof. For example, a sub-lane (also referred to as a lane segment or a traffic lane segment) may include a lane in which the vehicle is traveling within the region of interest.

For example, the processor 110 may obtain a first vector connecting the starting point of the sub-lane and a first point, which is the starting point translated by a first length in a forward direction (e.g., a longitudinal direction of a vehicle at the starting point and moving along the sub-lane). The first vector may be tangent to sub-lane at the starting point.

For example, the processor 110 may obtain a second vector connecting the end point of the sub-lane and a second point, which is the end point that is translated by the first length in a forward direction (e.g., a longitudinal direction of a vehicle at the end point and moving along the sub-lane). The second vector may be tangent to sub-lane at the end point.

For example, the processor 110 may identify whether the vehicle is traveling straight (or whether a path of the vehicle (e.g., along the sub-lane) is straight) based on the angle between the first vector and the second vector. For example, the path of the vehicle may be considered straight if the angle between the first vector and the second vector is zero (or less than a small threshold angle).

If the vehicle is not traveling straight, the processor 110 may identify whether the vehicle is turning left or right (or whether the path of the vehicle includes a left turn or a right turn) by performing a cross product of the first vector and the second vector.

Based on the lane attribute being identified as a first attribute indicating a left turn lane and the angle being greater than or equal to a reference angle, the processor 110 may identify that a road attribute including the lane attribute is a second attribute indicating a lane in which U-turns are permitted.

The processor 110 may identify drivable lanes within an intersection for vehicles including the vehicle. For example, the processor 110 may obtain directed graphs respectively corresponding to drivable lanes, based on identifying the drivable lanes.

For example, processor 110 may identify the type of an intersection based on directed graphs.

For example, the type of the intersection may include at least one of a three-way intersection, a three-way intersection without a left turn, a four-way intersection, a five-way intersection, a roundabout, an overpass, or an underpass, or any combination thereof.

The processor 110 may determine an intersection attribute based on a lane attribute and the type of an intersection.

The processor 110 may determine that the intersection attribute is a third attribute indicating a roundabout, based on the lane attribute being identified as a loop shape through successive identifications of the first attribute indicating that the lane attribute is left turn lane.

The processor 110 may control the operation of the vehicle by using an intersection attribute for the intersection. For example, the processor 110 may control the vehicle based on an intersection attribute.

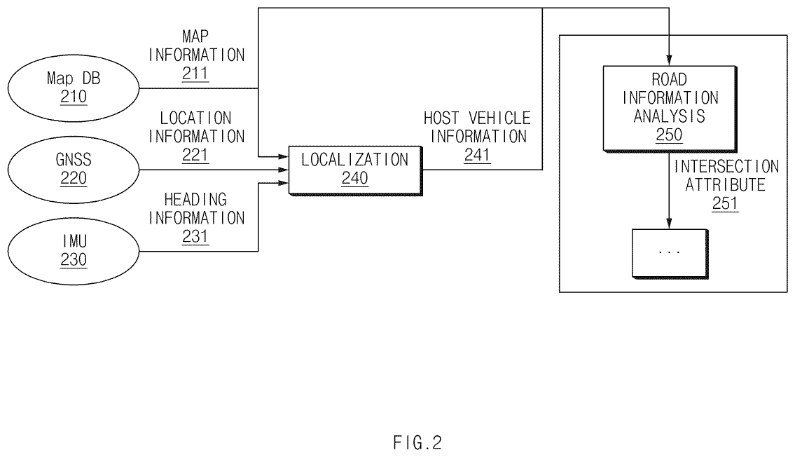

FIG. 2 shows an example of outputting an intersection attribute.

Referring to FIG. 2, a processor (e.g., processor 110 of FIG. 1) of a vehicle control device (e.g., the vehicle control device 100 of FIG. 1) may obtain map information 211 from a map DB 210. For example, the processor may obtain location information 221 from a global navigation satellite system (GNSS) 220. For example, the processor may obtain heading information 231 from an inertial measurement unit (IMU).

The processor may perform localization 240 on at least one of the map information 211, the location information 221, or the heading information 231, or any combination thereof.

For example, the processor may obtain host-vehicle information 241 by performing the localization 240 on at least one of the map information 211, the location information 221, or the heading information 231, or any combination thereof.

The processor may perform road information analysis 250 by using at least one of the map information 211 or the host-vehicle information 241, or any combination thereof. The processor may obtain an intersection attribute 251 based on performing the road information analysis 250 by using at least one of the map information 211 or the host-vehicle information 241, or any combination thereof.

The processor may output the intersection attribute 251 to control the operation and/or traveling of the vehicle based on obtaining the intersection attribute 251.

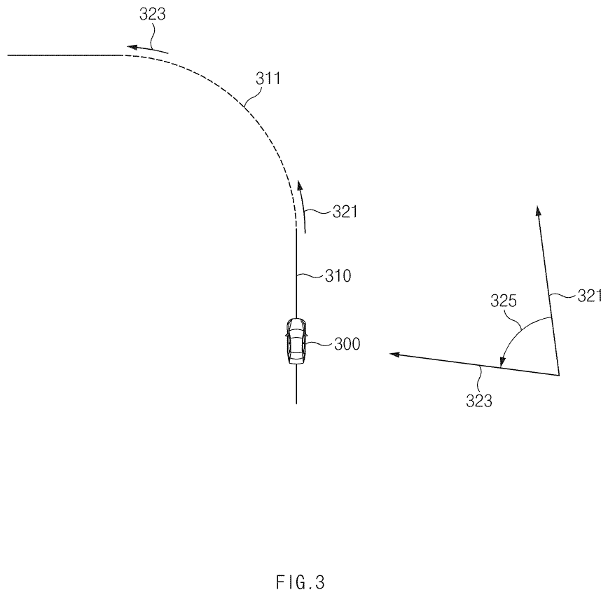

FIG. 3 shows an example of determining lane attributes.

Referring to FIG. 3, the processor (e.g., the processor 110 of FIG. 1) of a vehicle control device (e.g., the vehicle control device 100 of FIG. 1) may determine an attribute of a lane 310 in which the vehicle 300 is traveling.

For example, the processor may identify a curved road 311 in the lane 310 in which the vehicle 300 is traveling.

For example, the processor may obtain a first vector 321 connecting the start point of the curved road 311 and a first point spaced apart from the starting point of the curved road 311 by a specified distance in the traveling direction.

For example, the processor may obtain a second vector 323 connecting the end point of the curved road 311 and a second point spaced apart from the end point of the curved road 311 by the specified distance in the traveling direction.

The processor may identify the angle 325 between the first vector 321 and the second vector 323.

For example, based on the angle 325, the processor may identify whether the lane 310 in which the vehicle 300 is traveling is a left turn lane, a right turn lane, or a straight lane.

For example, the processor may perform a cross product of the first vector 321 and the second vector 323 based on the lane 310 not being a straight lane. For example, the processor may identify whether the lane 310 is a left turn lane or a right turn lane based on the result of the cross product of the first vector 321 and the second vector 323.

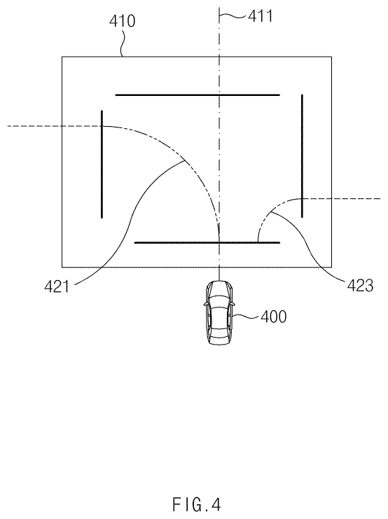

FIG. 4 shows an example of determining an intersection attribute.

Referring to FIG. 4, the processor (e.g., the processor 110 of FIG. 1) of a vehicle control device (e.g., the vehicle control device 100 of FIG. 1) may identify an intersection in a path 411 on which a vehicle 400 is traveling.

For example, the processor may identify an intersection based on identifying merging or diverging lanes 421 and 423 in the path 411.

For example, the processor may generate a bounding box 410 containing an intersection based on identifying the intersection.

For example, based on generating the bounding box 410 including an intersection, the processor may identify drivable lanes for vehicles including the vehicle 400, within the bounding box 410.

For example, the processor may identify the starting points of the drivable lanes and/or the end points of the drivable lanes based on identifying the drivable lanes for vehicles.

For example, the processor may obtain a directed graph, described below, based on the starting points of the drivable lanes and/or the end points of the drivable lanes.

For example, the processor may determine the type of the intersection based on obtaining the directed graph, and determine the attribute of the intersection by using the determined type of the intersection.

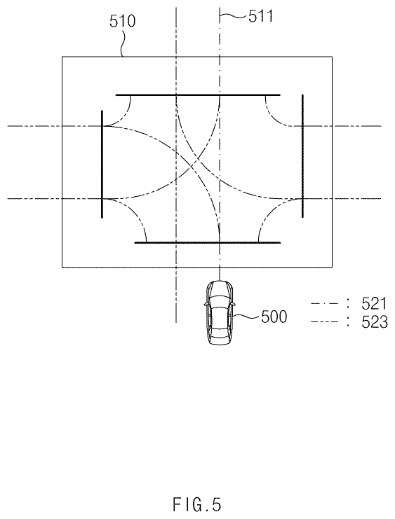

FIG. 5 shows an example of identifying lanes within an intersection.

Referring to FIG. 5, the processor (e.g., the processor 110 of FIG. 1) of a vehicle control device (e.g., the vehicle control device 100 of FIG. 1) may identify an intersection in a path 521 on which a vehicle 500 is traveling.

For example, the processor may generate a bounding box 510 containing an intersection based on identifying the intersection.

For example, the processor may identify lanes 523 that are different from a lane including the path 521 on which the vehicle 500 is traveling. For example, the processor may identify, within the bounding box 510, at least one of the lane including the path 521 on which the vehicle 500 is traveling, or lanes 523 that are different from a lane including the path 521 on which the vehicle 500 is traveling, or any combination thereof.

The processor may obtain, within the bounding box 510, directed graphs using the directionality of a road based on identifying at least one of the lane including the path 521 on which the vehicle 500 is traveling or the lanes 523 that are different from a lane including the path 521 on which the vehicle 500 is traveling, or any combination thereof.

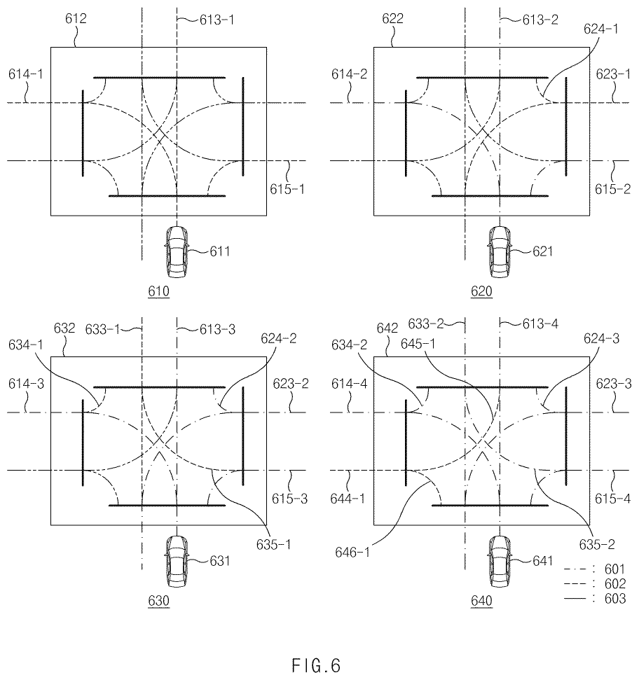

Obtaining directed graphs will be described later in FIG. 6.

FIG. 6 shows an example of obtaining directed graphs.

Referring to FIG. 6, the processor (e.g., the processor 110 of FIG. 1) of a vehicle control device (e.g., the vehicle control device 100 of FIG. 1) may obtain directed graphs 610, 620, 630, and 640.

For example, the processor may obtain the directed graphs 610, 620, 630, and 640 by using the starting point and/or end point of each of lanes included in an intersection.

Among lanes included in the directed graphs 610, 620, 630, and 640, a first lane 601 may include a lane that has been identified, a second lane 602 may include a lane based on lanes connecting from a specified starting point to end points, and a third lane 603 may include a lane that has not yet been identified.

The processor may obtain the first directed graph 610. For example, within the bounding box 612, the processor may identify lanes 614-1 and 615-1 that diverge from a starting point of the lane 613-1 on which the vehicle is traveling, based on the starting point and end point of the path on which the vehicle is traveling. For example, the processor may obtain the first directed graph 610 in which lanes 613-1, 614-1, and 615-1 are identified.

The processor may obtain the second directed graph 620 after obtaining the first directed graph 610. For example, the processor may identify the lanes 623-1 and 624-1 within the bounding box 622 using the starting points and end points of lanes that are different from the lane in which the vehicle 621 is traveling.

For example, the processor may obtain the second directed graph 620 including the lanes 613-2, 614-2, and 615-2 identified in the first directed graph 610 and the lanes 623-1 and 624-1 identified in the second directed graph 620.

The processor may obtain the third directed graph 630 after obtaining the second directed graph 620. For example, the processor may identify lanes 633-1, 634-1 and 635-1 within the bounding box 632 using the starting points and end points of lanes that are different from the lane in which the vehicle 631 is traveling.

For example, the processor may identify the lanes 633-1, 634-1, and 635-1 using the starting points and end points of lanes different from the lanes 613-3, 614-3, 615-3, 623-2, and 624-2 identified in the first directed graph 610 and the second directed graph 620.

For example, the processor may obtain the third directed graph 630 based on identifying the lanes 633-1, 634-1, and 635-1 using the starting points and end points of lanes different from the lanes 613-3, 614-3, 615-3, 623-2, and 624-2 identified in the first directed graph 610 and the second directed graph 620.

The processor may obtain the fourth directed graph 640 after obtaining the third directed graph 630. For example, the processor may obtain the fourth directed graph 630 based on identifying the lanes 644-1, 645-1 and 646-1 within the bounding box 642 using the starting points and end points of lanes that are different from the lane in which the vehicle 641 is traveling.

For example, the processor may obtain the fourth directed graph 640 based on identifying the lanes 644-1, 645-1, and 646-1 using the starting points and end points of lanes different from the lanes 613-4, 614-4, 615-4, 623-3, 624-3, 633-2, 634-2, 635-2 identified in the third directed graph 640.

The processor may identify an intersection type based on the directed graphs. For example, the processor may determine an intersection attribute based on identifying the intersection type by further using the intersection type and other conditions. For example, the other conditions may include at least one of whether there is a left turn, whether there is a U-turn, or whether an infinite loop occurs, or any combination thereof.

TABLE 1

| Reference Table | | Number of directed graphs | | |
|---|---|---|---|---|
| for logic determination | | 3 | 4 | 5 |
| Whether | X | Three-way | Unknown | Unknown |
| there is | | intersec- | | |
| lane with | | tion without | | |
| left-turn | | left turn | | |
| attribute | ◯ | Three-way | Four-way | Five-way |
| | | intersec- | intersec- | intersec- |
| | | tion | tion | tion |
| | ◯ (Section has | Roundabout | | |
| | been found in which | | | |
| | there are successive | | | |
| | lanes with left-turn | | | |
| | attribute and | | | |
| | starting points of | | | |
| | successive lanes are | | | |
| | identical) | | | |

For example, the processor may determine an intersection attribute, referring to Table 1. For example, the processor may identify whether the lane attribute is a left-turn attribute and determine the intersection attribute according to the number of directed graphs.

For example, if there is no lane with a left-turn attribute, the processor may identify that the intersection attribute is a three-way intersection without a left turn, based on the number of directed graphs being identified as three.

For example, if there is no lane with the left-turn attribute, the processor may output a flag indicating that an intersection attribute is unknown based on the number of directed graphs being identified as four or five.

For example, if there is a lane with the left-turn attribute, the processor may identify that the intersection attribute is a three-way intersection, based on the number of directed graphs being identified as three.

For example, if there is a lane with the left-turn attribute, the processor may identify that the intersection attribute is a four-way intersection, based on the number of directed graphs being identified as four.

For example, if there is a lane with the left-turn attribute, the processor may identify that the intersection attribute is a five-way intersection, based on the number of directed graphs being identified as five.

For example, the processor may identify that the intersection attribute is a roundabout, regardless of the number of directed graphs, if a section has been found in which there are successive lanes with the left-turn attribute and the starting points of the successive lanes are identical.

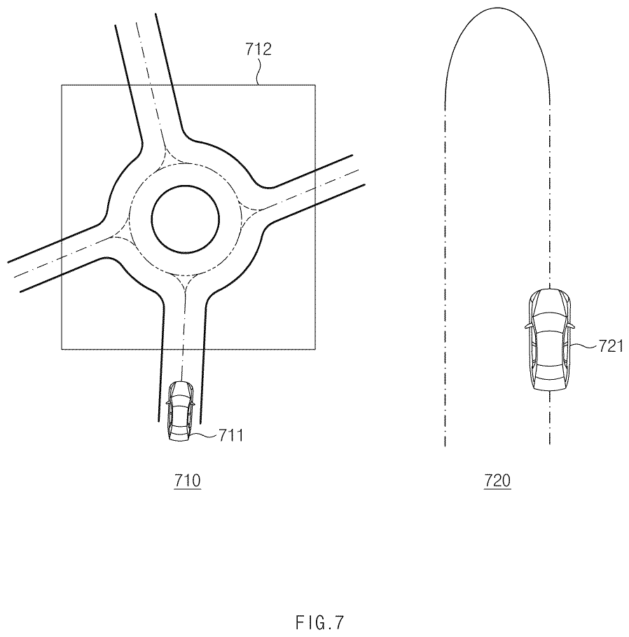

FIG. 7 shows an example of identifying a roundabout and/or a U-turn lane.

Referring to FIG. 7, the processor (e.g., the processor 110 of FIG. 1) of a vehicle control device (e.g., the vehicle control device 100 of FIG. 1) may identify at least one of a roundabout or a lane in which U-turns are permitted, or any combination thereof.

Referring to a first example 710, the processor may identify an intersection ahead of a vehicle 711 while the vehicle 711 is traveling. The processor may generate a bounding box 712 including the intersection based on identifying the intersection ahead of the vehicle 711.

For example, the processor may identify that the intersection included in the bounding box 712 is in the form of a loop because lanes with the left-turn attribute are determined successively. The processor may identify that the intersection attribute of the intersection included in the bounding box 712 is an attribute indicating a roundabout based on identifying that the intersection included in the bounding box 712 is a loop shape because lanes with left-turn attribute are determined successively.

As described above, the processor of the vehicle control device may determine that the intersection is a roundabout by determining the intersection attribute using the left-turn attribute, even if the number of entrances of the roundabout and/or the number of exits of the roundabout are different. Additionally, the processor may be able to prepare for an accident situation that may occur at a roundabout by identifying the roundabout.

Referring to a second example 720, the processor may identify that a lane in which the vehicle 721 is traveling is a lane in which U-turns are permitted. For example, the processor may obtain a starting point vector and an end point vector of a lane with a left-turn attribute. The processor may identify an included angle between the starting point vector and the end point vector based on obtaining the starting point vector and the end point vector of the lane with the left-turn attribute.

For example, based on obtaining the vectors of the starting point and the end point of the lane with the left-turn attribute, the processor may identify that a corresponding lane is a lane in which U-turns are permitted if the included angle between the vectors of the starting point and the end point is greater than a reference value.

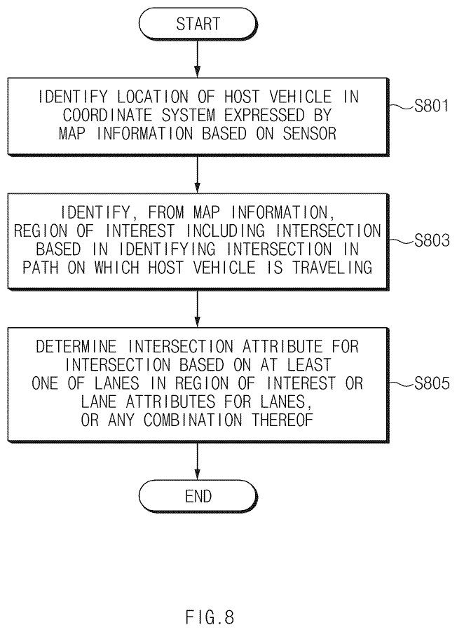

FIG. 8 shows an example of a flowchart related to a vehicle control method.

Hereinafter, it is assumed that the vehicle control device 100 of FIG. 1 performs the process of FIG. 8. Additionally, in the description of FIG. 8, operations described as being performed by the device may be understood as being controlled by the processor 110 of the vehicle control device 100.

At least one of operations in FIG. 8 may be performed by the vehicle control device 100 in FIG. 1. At least one of the operations in FIG. 8 may be controlled by the processor 110 in FIG. 1. The operations in FIG. 8 may be performed sequentially, but is not necessarily performed sequentially. For example, the order of the operations may be changed, and at least two operations may be performed in parallel.

Referring to FIG. 8, in operation S801, a vehicle control method may include identifying the location of a vehicle in a coordinate system expressed by map information based on a sensor.

For example, the sensor may include at least one of a GPS sensor, a gyro sensor, an acceleration sensor, or a geomagnetic sensor, or any combination thereof. However, the present disclosure is not limited to what described above.

For example, the vehicle control method may include identifying, from the map information, sub-lanes that diverge or merge within a path on which the vehicle is traveling based on identifying the location of the vehicle.

For example, the vehicle control method may include identifying, within a region of interest, an intersection containing sub-lanes.

In operation S803, the vehicle control method may include identifying, from map information, a region of interest including the intersection based on identifying the intersection within the path on which the vehicle is traveling.

In operation S805, the vehicle control method may include determining an intersection attribute for the intersection based on at least one of lanes in the region of interest or lane attributes of the lanes, or any combination thereof.

For example, the vehicle control method may include identifying lane attributes based on at least one of the starting point of a sub-lane or the end point of the sub-lane, or any combination thereof.

For example, a sub-lane may be, for example, a portion, of a lane in which the vehicle is traveling, that is inside the region of interest.

For example, the vehicle control method may include obtaining a first vector connecting the starting point of the sub-lane and a first point spaced forward by a first length from the starting point of the sub-lane. The first point may be located at a point where the start point that is translated by the first length in a forward direction (e.g., a longitudinal direction of a vehicle at the start point and moving along the sub-lane). For example, the first vector may be referred to as a starting point vector.

For example, the vehicle control method may include obtaining a second vector connecting the end point of the sub-lane and a second point spaced forward by the first length from the end point of the sub-lane. The second point may be located at a point where the end point that is translated by the first length in a forward direction (e.g., a longitudinal direction of a vehicle at the end point and moving along the sub-lane). For example, the direction ahead from the end point of the sub-lane may include a direction substantially the same as the direction of travel of the vehicle. For example, the second vector may be referred to as an end point vector.

For example, the vehicle control method may include identifying whether the vehicle is traveling straight based on the angle between the first vector and the second vector. For example, the vehicle control method may include identifying whether the vehicle is traveling straight, based on the angle between the starting point vector and the end point vector.

For example, the vehicle control method may include identifying that the vehicle is not traveling straight. For example, the vehicle control method may include performing a cross product of the first vector and the second vector if the vehicle is not traveling straight. The vehicle control method may include identifying whether the vehicle is turning left or right by performing a cross product of the first vector and the second vector if the vehicle is not traveling straight.

For example, the vehicle control method may include identifying that a road attribute including the lane attribute is a second attribute indicating a lane in which U-turns are permitted, based on the lane attribute being identified as a first attribute indicating a left turn lane and the angle between the first vector and the second vector being greater than or equal to a reference angle.

For example, the vehicle control method may include identifying drivable lanes within the intersection for vehicles including the vehicle. For example, the vehicle control method may include obtaining directed graphs respectively corresponding to drivable lanes, based on identifying the drivable lanes.

For example, the vehicle control method may include identifying the type of the intersection based on the directed graphs.

For example, the vehicle control method may include determining that the intersection attribute is a third attribute indicating a roundabout, based on the lane attribute being identified as a loop shape through successive identifications of the first attribute indicating that the lane attribute is left turn lane.

For example, the types of the intersection may include at least one of a three-way intersection, a three-way intersection without a left turn, a four-way intersection, a five-way intersection, a roundabout, an overpass, or an underpass, or any combination thereof. However, the present disclosure is not limited to the above.

For example, the vehicle control method may include determining an intersection attribute based on the lane attribute and the intersection type.

The vehicle control method may include controlling at least one of the traveling of the vehicle or the operation of the vehicle, or any combination thereof, based on determining the intersection attribute of the intersection. For example, the vehicle control method may include controlling the vehicle based on the intersection attribute.

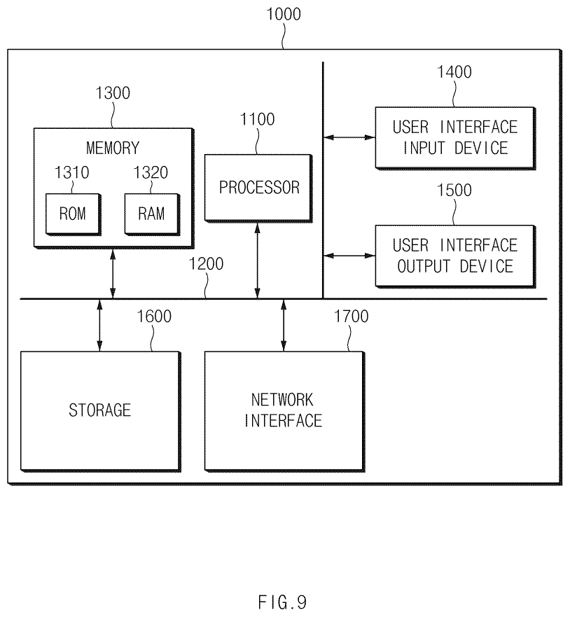

FIG. 9 shows a computing system related to a vehicle control device or a vehicle control method.

Referring to FIG. 9, a computing system 1000 may include at least one processor 1100, a memory 1300, a user interface input device 1400, a user interface output device 1500, storage 1600, and a network interface 1700, which are connected with each other via a bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a read-only memory (ROM) and a random-access memory (RAM).

Thus, the operations of the method or the algorithm described disclosed herein may be embodied directly in hardware or a software module executed by the processor 1100, or in a combination thereof. The software module may reside on a storage medium (that is, the memory 1300 and/or the storage 1600) such as a RAM, a flash memory, a ROM, an EPROM, an EEPROM, a register, a hard disk, a removable disk, and a CD-ROM.

The example storage medium may be coupled to the processor 1100, and the processor 1100 may read information out of the storage medium and may record information in the storage medium. Alternatively, the storage medium may be integrated with the processor 1100. The processor 1100 and the storage medium may reside in an application specific integrated circuit (ASIC). The ASIC may reside within a user terminal. In another case, the processor 1100 and the storage medium may reside in the user terminal as separate components.

According to an aspect of the present disclosure, a vehicle control device may include a memory that stores map information, a sensor that identifies a location of a vehicle or a heading direction of the vehicle, or any combination thereof, and a processor. The processor may identify a location of the vehicle in a coordinate system represented by the map information based on the sensor, identify, from the map information, a region of interest (ROI) including the intersection, based on identifying an intersection within a path on which the vehicle is traveling, determine an intersection attribute for the intersection based on at least one of lanes in the region of interest or lane attributes for the lanes, or any combination thereof, and control the vehicle based on the intersection attribute.

The processor may identify, from the map information, sub-lanes that diverge or merge within the path on which the vehicle is traveling based on identifying the location of the vehicle, and identify, within the region of interest, the intersection including the sub-lanes.

The processor may identify the lane attribute based on at least one of a start point of the sub-lane, or an end point of the sub-lane, or any combination thereof. The sub-lanes may include a lane on which the vehicle is traveling within the region of interest.

The processor may obtain a first vector connecting the start point of the sub-lane and a first point spaced forward by a first length from the start point of the sub-lane, obtain a second vector connecting the end point of the sub-lane and a second point spaced forward by the first length from the end point of the sub-lane, and identify whether the vehicle is traveling straight based on an angle between the first vector and the second vector.

The processor may identify whether the vehicle is turning left or right by performing a cross product of the first vector and the second vector if the vehicle is not traveling straight.

The processor may identify that a road attribute including the lane attribute is a second attribute indicating a lane in which U-turns are permitted, based on the lane attribute being identified as a first attribute indicating a left turn lane and the angle being greater than or equal to a reference angle.

The processor may identify drivable lanes within the intersection for vehicles including the vehicle, and obtain directed graphs respectively corresponding to drivable lanes, based on identifying the drivable lanes.

The processor may identify a type of the intersection based on the directed graphs.

The type of the intersection may include at least one of a three-way intersection, a three-way intersection without a left turn, a four-way intersection, a five-way intersection, a roundabout, an overpass, or an underpass, or any combination thereof.

The processor may determine the intersection attribute based on the lane attribute and the type of the intersection.

The processor may determine that the intersection attribute is a third attribute indicating a roundabout, based on the lane attribute being identified as a loop shape through successive identifications of the first attribute indicating that the lane attribute is left turn lane.

The sensor may include at least one of a GPS sensor, a gyro sensor, an acceleration sensor, or a geomagnetic sensor, or any combination thereof.

A vehicle control method may identifying, by a processor, a location of a vehicle in a coordinate system represented by map information based on a sensor, identifying, by the processor, a region of interest (ROI) including the intersection from the map information, based on identifying an intersection within a path on which the vehicle is traveling, determining, by the processor, an intersection attribute for the intersection based on at least one of lanes in the region of interest or lane attributes for the lanes, or any combination thereof, and controlling, by the processor, the vehicle based on the intersection attribute.

The vehicle control method may further include identifying, from the map information, sub-lanes that diverge or merge within the path on which the vehicle is traveling based on identifying the location of the vehicle, and identifying, within the region of interest, the intersection including the sub-lanes.

The vehicle control method may further include identifying the lane attribute based on at least one of a start point of the sub-lane, or an end point of the sub-lane, or any combination thereof. The sub-lanes may include a lane on which the vehicle is traveling within the region of interest.

The vehicle control method may further include obtaining a first vector connecting the start point of the sub-lane and a first point spaced forward by a first length from the start point of the sub-lane, obtaining a second vector connecting the end point of the sub-lane and a second point spaced forward by the first length from the end point of the sub-lane, and identifying whether the vehicle is traveling straight based on an angle between the first vector and the second vector.

The vehicle control method may further include identifying whether the vehicle is turning left or right by performing a cross product of the first vector and the second vector if the vehicle is not traveling straight.

The vehicle control method may further include identifying that a road attribute including the lane attribute is a second attribute indicating a lane in which U-turns are permitted, based on the lane attribute being identified as a first attribute indicating a left turn lane and the angle being greater than or equal to a reference angle.

The vehicle control method may further include identifying drivable lanes within the intersection for vehicles including the vehicle, and obtaining directed graphs respectively corresponding to drivable lanes, based on identifying the drivable lanes.

The vehicle control method may further include identifying a type of the intersection based on the directed graphs, determining the intersection attribute based on the lane attribute and the type of the intersection, and the type of the intersection includes at least one of a three-way intersection, a three-way intersection without a left turn, a four-way intersection, a five-way intersection, a roundabout, an overpass, or an underpass, or any combination thereof.

The above description is merely illustrative of the technical idea of the present disclosure, and various modifications and variations may be made without departing from the essential characteristics of the present disclosure by those skilled in the art to which the present disclosure pertains.

Accordingly, the one or more example embodiments disclosed in the present disclosure are not intended to limit the technical idea of the present disclosure but to describe the present disclosure, and the scope of the technical idea of the present disclosure is not limited by these example embodiments. The scope of protection of the present disclosure should be interpreted by the following claims, and all technical ideas within the scope equivalent thereto should be construed as being included in the scope of the present disclosure.

The present technology may accurately determine an intersection attribute of an intersection by using lane attributes of lanes included in the intersection.

Further, the present technology may establish a driving strategy corresponding to road conditions by accurately determining an intersection attribute.

Further, the present technology may accurately determine an intersection attribute by determining the intersection attribute using map information and vehicle sensor information.

In addition, various effects may be provided that are directly or indirectly understood through the disclosure.

Hereinabove, although the present disclosure has been described with reference to one or more example embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A vehicle control device of a vehicle, the vehicle control device comprising:
memory configured to store map information;
a sensor configured to determine at least a location of the vehicle or a heading of the vehicle; and
a processor configured to:
determine, based on at least one of the location of the vehicle or the heading of the vehicle, an intersection on a path of the vehicle;
determine, based on the map information, a region of interest that comprises the intersection;
determine, based on at least one of a traffic lane in the region of interest or a lane attribute of the traffic lane, an intersection attribute of the intersection; and
control, based on the intersection attribute, an operation of the vehicle.

2. The vehicle control device of claim 1, wherein the processor is further configured to:
determine, from the map information and based on the location of the vehicle, a lane segment that diverges or merges within the path of the vehicle; and
determine, within the region of interest, the intersection that comprises the lane segment.

3. The vehicle control device of claim 1, wherein the processor is further configured to:
determine, based on at least one of a starting point of a lane segment or an end point of the lane segment, the lane attribute, and
wherein the lane segment comprises a portion, of the traffic lane in which the vehicle is traveling, that is inside the region of interest.

4. The vehicle control device of claim 3, wherein the processor is further configured to:
determine a first vector tangent to the lane segment at the starting point of the lane segment;
determine a second vector tangent to the lane segment at the end point of the lane segment; and
determine, based on an angle between the first vector and the second vector, whether the path of the vehicle along the lane segment is straight.

5. The vehicle control device of claim 4, wherein the processor is further configured to:
determine, based on a cross product of the first vector and the second vector, whether the path of the vehicle comprises a left turn or a right turn.

6. The vehicle control device of claim 4, wherein the processor is configured to determine the intersection attribute by:
determining, based on the lane attribute indicating a left turn lane and based on the angle being greater than a threshold value, that U-turns are permitted in the intersection.

7. The vehicle control device of claim 1, wherein the processor is further configured to:
determine drivable lanes within the intersection; and
determine directed graphs respectively corresponding to the drivable lanes.

8. The vehicle control device of claim 7, wherein the processor is further configured to:
determine, based on the directed graphs, a type of the intersection.

9. The vehicle control device of claim 8, wherein the type of the intersection comprises at least one of: a three-way intersection, a three-way intersection without a left turn, a four-way intersection, a five-way intersection, a roundabout, an overpass, or an underpass.

10. The vehicle control device of claim 8, wherein the processor is further configured to determine the intersection attribute by:
determining the intersection attribute based on the lane attribute and the type of the intersection.

11. The vehicle control device of claim 1, wherein the processor is configured to determine the intersection attribute by:
determining, based on the lane attribute successively indicating a plurality of left turns, that the lane attribute further indicates a loop; and
determining, based on the lane attribute indicating the loop, that the intersection attribute indicates a roundabout.

12. The vehicle control device of claim 1, wherein the sensor comprises at least one of: a global positioning system (GPS) sensor, a gyroscope, an accelerometer, or a magnetometer.

13. A method performed by an apparatus of a vehicle, the method comprising:
determining, by a processor of the vehicle and based on at least one of a location of the vehicle or a heading of the vehicle, an intersection on a path of the vehicle;
determining, by the processor and based on map information stored in memory of the vehicle, a region of interest that comprises the intersection;
determining, by the processor and based on at least one of a traffic lane in the region of interest or a lane attribute of the traffic lane, an intersection attribute of the intersection; and
controlling, by the processor based on the intersection attribute, an operation of the vehicle.

14. The method of claim 13, further comprising:
determining, from the map information and based on the location of the vehicle, a lane segment that diverges or merges within the path of the vehicle; and
determining, within the region of interest, the intersection that comprises the lane segment.

15. The method of claim 13, further comprising:
determining, based on at least one of a starting point of a lane segment, or an end point of the lane segment, the lane attribute,
wherein the lane segment comprises a portion, of the traffic lane in which the vehicle is traveling, that is inside the region of interest.

16. The method of claim 15, further comprising:
determining a first vector tangent to the lane segment at the starting point of the lane segment;
determining a second vector tangent to the lane segment at the end point of the lane segment; and
determining, based on an angle between the first vector and the second vector, whether the path of the vehicle along the lane segment is straight.

17. The method of claim 16, further comprising:
determining, based on a cross product of the first vector and the second vector, whether the path of the vehicle comprises a left turn or a right turn.

18. The method of claim 16, wherein the determining of the intersection attribute comprises:
determining, based on the lane attribute indicating a left turn lane and based on the angle being greater than a threshold value, that U-turns are permitted in the intersection.

19. The method of claim 13, further comprising:
determining drivable lanes within the intersection; and
determining directed graphs respectively corresponding to the drivable lanes.

20. The method of claim 19, further comprising:
determining, based on the directed graphs, a type of the intersection,
wherein the determining of the intersection attribute comprises:
determining the intersection attribute based on the lane attribute and the type of the intersection, and
wherein the type of the intersection comprises at least one of: a three-way intersection, a three-way intersection without a left turn, a four-way intersection, a five-way intersection, a roundabout, an overpass, or an underpass.
